(19) United States
(12) Patent Application Publication
(10) Pub. No.: US 2018/0365649 A1
(43) Pub. Date: Dec. 20, 2018

(54) ATTENDANCE PROCESSING METHOD AND APPARATUS

(71) Applicant: Alibaba Group Holding Limited, Grand Cayman (KY)

(72) Inventors: Liying Yu, Hangzhou (CN); Lamei Zhang, Zhejiang (CN); Feng Bao, Hangzhou (CN); Chenlu Guo, Hangzhou (CN)

(73) Assignee: Alibaba Group Holding Limited

(21) Appl. No.: 16/125,129

(22) Filed: Sep. 7, 2018

Related U.S. Application Data
(63) Continuation of application No. PCT/CN2017/074631, filed on Feb. 23, 2017.

(30) Foreign Application Priority Data
Mar. 9, 2016 (CN) 201610134553.5

(51) Int. Cl. G06Q 10/10

(52) U.S. Cl. CPC G06Q 10/1091

(57) ABSTRACT

A method including determining a preset attendance event corresponding to a group to which a user belongs; acquiring attendance-related information corresponding to the user in the preset attendance event, and presenting the attendance-related information to the user. This method may arouse the attendance enthusiasm of users and help improve user experience.

### CROSS REFERENCE TO RELATED PATENT APPLICATIONS

This application claims priority to and is a continuation of PCT Patent Application No. PCT/CN2017/074631, filed on 23 Feb. 2017, which claims priority to Chinese Patent Application No. 201610134553.5 filed on 9 Mar. 2016 and entitled “ATTENDANCE PROCESSING METHOD AND APPARATUS”, which are incorporated herein by reference in their entirety.

### TECHNICAL FIELD

The present disclosure relates to the field of Internet technologies, and, more particularly, to attendance processing methods and apparatuses.

### BACKGROUND

An attendance (also referred to as clock-in) system may acquire and collect statistics about on-duty or off-duty states of users, thus helping managers learn about the working statuses of employees.

However, by using the attendance manner in the conventional technologies, a user may only know whether his/her attendance operation is successful, but cannot know his/her attendance performance, and therefore cannot make improvements, which is not conducive to the development of the user and a related group (such as an enterprise).

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides an attendance processing method and apparatus, which may arouse the attendance enthusiasm of users and help improve user experience.

The present disclosure provides the following technical solutions:

According to a first aspect of the present disclosure, an attendance processing method is provided, including:

determining a preset attendance event corresponding to a group to which a user belongs;

acquiring attendance-related information corresponding to the user in the preset attendance event; and

presenting the attendance-related information to the user.

According to a second aspect of the present disclosure, an attendance processing apparatus is provided, including:

a determination unit configured to determine a preset attendance event corresponding to a group to which a user belongs;

an acquisition unit configured to acquire attendance-related information corresponding to the user in the preset attendance event; and

a presentation unit configured to present the attendance-related information to the user.

As shown from the foregoing technical solution, the present disclosure determines a preset attendance event corresponding to a user and presents attendance-related information corresponding to the user, thus helping the user view the attendance-related information, achieving a corresponding stimulation effect, and improving user experience.

### BRIEF DESCRIPTION OF THE DRAWINGS

The accompanying drawings described herein are used to provide further understanding about the present disclosure and constitute a part of the present disclosure. Schematic example embodiments of the present disclosure and description thereof are used to explain the present disclosure, and do not constitute improper limitations to the present disclosure.

FIG. 1 is a flowchart of an attendance processing method according to an example embodiment of the present disclosure;

FIG. 2 is a flowchart of another attendance processing method according to an example embodiment of the present disclosure;

FIG. 3 to FIG. 13 are schematic diagrams of an attendance page according to an example embodiment of the present disclosure;

FIG. 14 is a schematic structural diagram of an electronic device according to an example embodiment of the present disclosure; and

FIG. 15 is a block diagram of an attendance processing apparatus according to an example embodiment of the present disclosure.

### DETAILED DESCRIPTION

To enable those skilled in the art better understand the solutions of the present disclosure, the technical solutions in the example embodiments of the present disclosure will be described below with reference to the accompanying drawings in the example embodiments of the present disclosure. The example embodiments described are only some, rather than all, of the example embodiments of the present disclosure. All other example embodiments derived by those of ordinary skill in the art based on the example embodiments of the present disclosure without creative efforts should fall within the protection scope of the present disclosure.

The following example embodiments are provided for further description of the present disclosure.

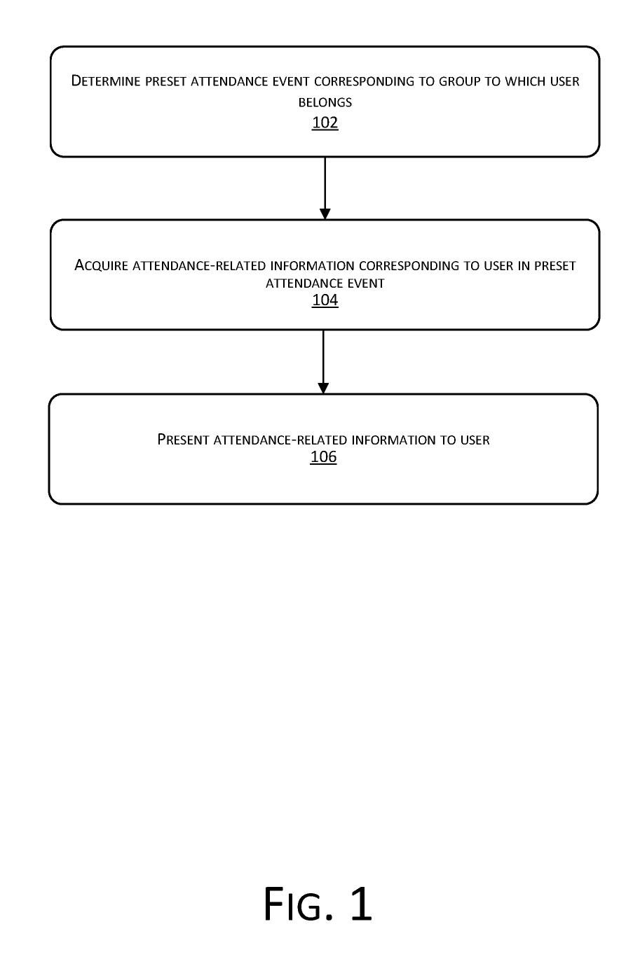

FIG. 1 is a flowchart of an attendance processing method according to an example embodiment of the present disclosure. As shown in FIG. 1, the method is applied to an electronic device, and may include the following steps:

Step 102: A preset attendance event corresponding to a group to which a user belongs is determined.

In this embodiment, the group to which the user belongs may be a class, a group, a department, an enterprise, or another type of group. Each group may configure a corresponding preset attendance event according to an actual requirement of the group. For example, a preset attendance event of a class may include: on-duty attendance for arriving at the school before 8:00 am, and off-duty attendance for leaving the school after 5:00 pm. A preset attendance event of an enterprise may include: on-duty attendance for arriving at the company before 9:00 am, and off-duty attendance for leaving the company after 6:00 pm. Moreover, each group may set various temporary preset attendance events according to actual requirements.

Step 104: Attendance-related information corresponding to the user in the preset attendance event is acquired.

Step 106: The attendance-related information is presented to the user.

In this embodiment, the attendance-related information refers to all information related to the current user in the preset attendance event. For example, an attendance rank, prompt information related to the attendance rank, a preset feature attribute of a performed attendance operation, assistant scenario information, and the like may all be presented to the user.

In this embodiment, the sorting manner of the attendance rank is related to the corresponding preset attendance event. When the preset attendance event is of an on-duty type, a user who performs the attendance operation earlier has a correspondingly higher attendance rank. When the preset attendance is of an off-duty type, a user who performs the attendance operation later has a correspondingly higher attendance rank. For example, a user who performs the on-duty attendance earliest and a user who performs the off-duty attendance latest both rank the first in corresponding attendance ranking.

In this embodiment, by taking “on-duty attendance for arriving at the company before 9:00 am” as an example, the attendance time specified in the preset attendance event is “before 9:00 am”. In fact, users may be unable to perform the attendance operation within the time period “before 9:00 am” due to various reasons. In this case, a preset time period after “9:00 am”, e.g., “from 9:00 am to 10:00 am”, may be defined such that the attendance operation happening within the preset time period still corresponds to the “on-duty attendance for arriving at the company before 9:00 am”. After the preset time period (e.g., at 11:00 am), it may be determined that the user fails to perform the attendance operation.

In this embodiment, the preset prompt information may include at least one of the following: the attendance rank, and evaluative description information for the attendance rank. When a user has a high attendance rank, the evaluative description information may be high evaluation and incentive description information. When a user has a low attendance rank, the evaluative description information may be encouraging description information, which helps the user learn of the problem with his/her attendance, and encourages the user to raise his/her attendance rank.

In this embodiment, the preset feature attribute of the attendance operation may include at least one of the following: an attendance time, an attendance site, and the like. Each attendance event has a pre-defined standard attendance time and a standard attendance site. For example, “arriving at the company before 9:00 am” indicates that: the standard attendance time is “before 9:00 am” and the standard attendance site is “company”. However, the user may fail to accurately meet the foregoing standard attendance time and standard attendance site due to various reasons. Therefore, an actual attendance time and an actual attendance site may be shown such that the user may conveniently view and adjust his/her attendance status accordingly.

In this embodiment, assistant scenario information of a preset type may include at least one of the following: weather information, starry sky patterns, important events, and the like related to preset feature attributes of the attendance operation such as time and site. Especially, when the user looks through attendance record information corresponding to the preset attendance event after a long time, the associated record of the assistant scenario information enables the user to view the assistant scenario information while viewing the attendance record, thus helping the user remember the historical scene at that time, further improving user experience.

As may be seen from the foregoing technical solution, the present disclosure determines a preset attendance event corresponding to a user and shows attendance-related information corresponding to the user so that the user may view the attendance-related information, achieving a corresponding stimulation effect for the user, and improving user experience.

In the technical solution of the present disclosure, a user installs an application having an attendance function in an electronic device such as a mobile phone and a tablet computer in advance. Therefore, the user may perform the attendance function by using the application within a time period and at a geographic location defined by a preset attendance event, and the application may correspondingly send an attendance request to a preset server and complete the attendance operation. Then, the application may receive information such as an attendance rank returned by the server, such that the application may implement the attendance processing method of the present disclosure on the electronic device.

The application may be a preset instant messaging application. For example, the application may be an Enterprise Instant Messaging (EIM) application, such as DING Talk.

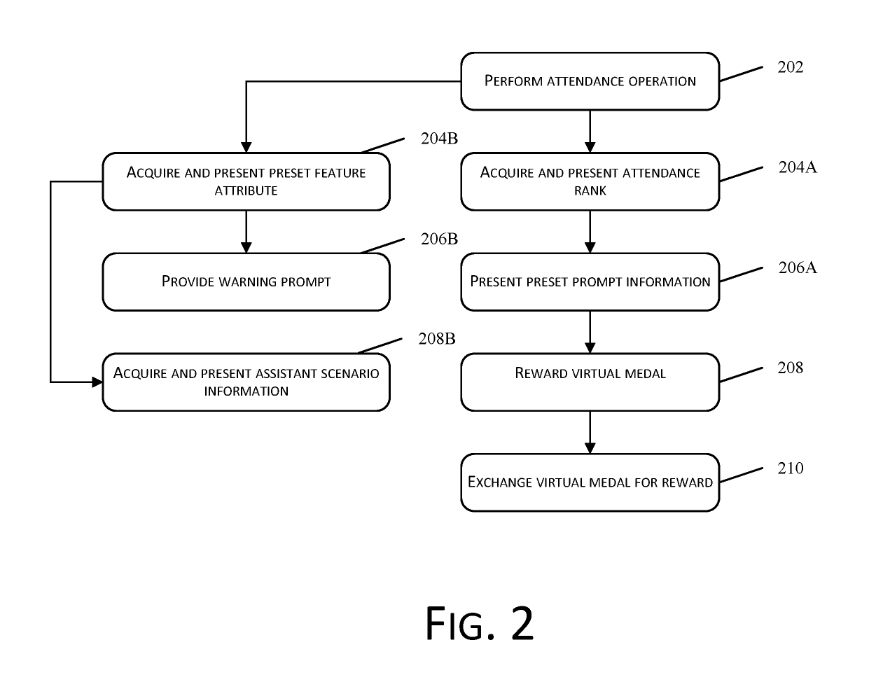

For ease of understanding, the technical solution of the present disclosure is described in detail in the following for a built-in attendance function of the EIM application DING Talk. FIG. 2 is a flowchart of another attendance processing method according to an example embodiment of the present disclosure. The method may include the following steps:

Step 202: An attendance operation is performed.

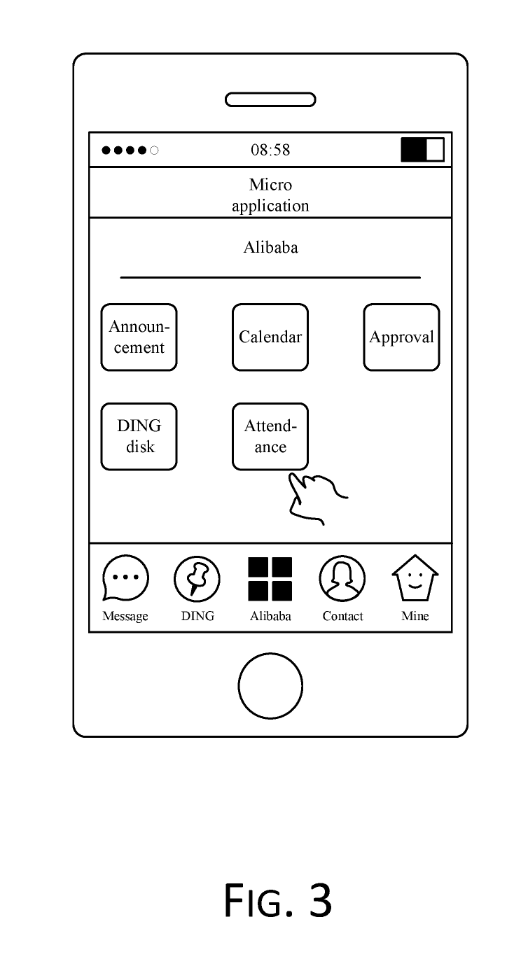

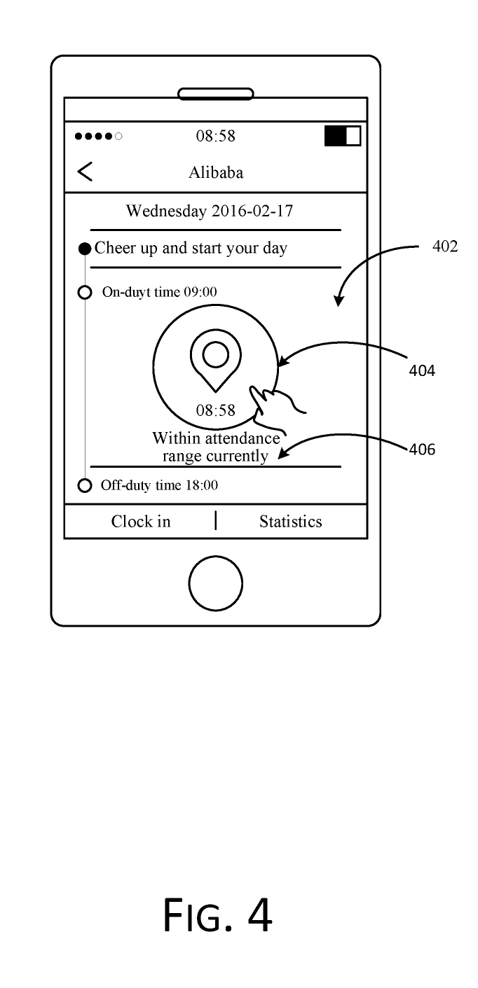

In this embodiment, as shown in FIG. 3, a user may view an attendance function configured in DING Talk through, for example, an “Alibaba” tab page. For example, when the user clicks an “attendance” icon, an attendance page as shown in FIG. 4 may be redirected to.

As shown in FIG. 4, an associated presentation region 402 located between “Cheer up and start your day” and “the off-duty time is 18:00” is defined in the attendance page for an attendance event “on-duty attendance”. A trigger identifier 404 for the attendance event, such as a round trigger identifier occupying a relatively large area in the associated presentation region, is shown in the associated presentation region. As such, the user may implement the corresponding attendance operation by clicking on the trigger identifier. The trigger identifier 404 occupies a large area, is located at the center of the attendance page, and presents key information concerned by the user, thus making it convenient for the user to read information and perform the attendance operation.

Attendance prompt information may be shown in an associated region inside or near the trigger identifier of the attendance operation. For example, in FIG. 4, the current time “08:58” may be shown inside the trigger identifier 404, and “within the attendance range currently” (indicating that the current site conforms to the pre-defined standard attendance site) may be shown in an associated region 406 below the trigger identifier.

After the user finishes the attendance operation, attendance-related information for the corresponding attendance event may be further shown. For example, the attendance-related information may be presented in the trigger identifier, such that presented content (i.e., the “attendance prompt information” and the “attendance-related information”) before and after the attendance operation correspond to each other, thus facilitating the user to view the presented content and providing a prompt and stimulation for the user.

In the technical solution of the present disclosure, the attendance-related information may include various types, which will be listed and illustrated respectively in the following:

Step 204A: An attendance rank is acquired and presented.

In this embodiment, the attendance rank is related to, but different from, the order of performing the attendance operation by the user. For example, in a scenario of on-duty attendance, the attendance rank is consistent with the order of performing the attendance operation. For example, the first user performing the attendance operation corresponds to the first attendance rank, the third user performing the attendance operation corresponds to the third attendance rank, and the last user performing the attendance operation corresponds to the last attendance rank. In a scenario of off-duty attendance, the attendance rank is reverse to the order of performing the attendance operation. For example, the first user performing the attendance operation corresponds to the last attendance rank, and the last user performing the attendance operation corresponds to the first attendance rank.

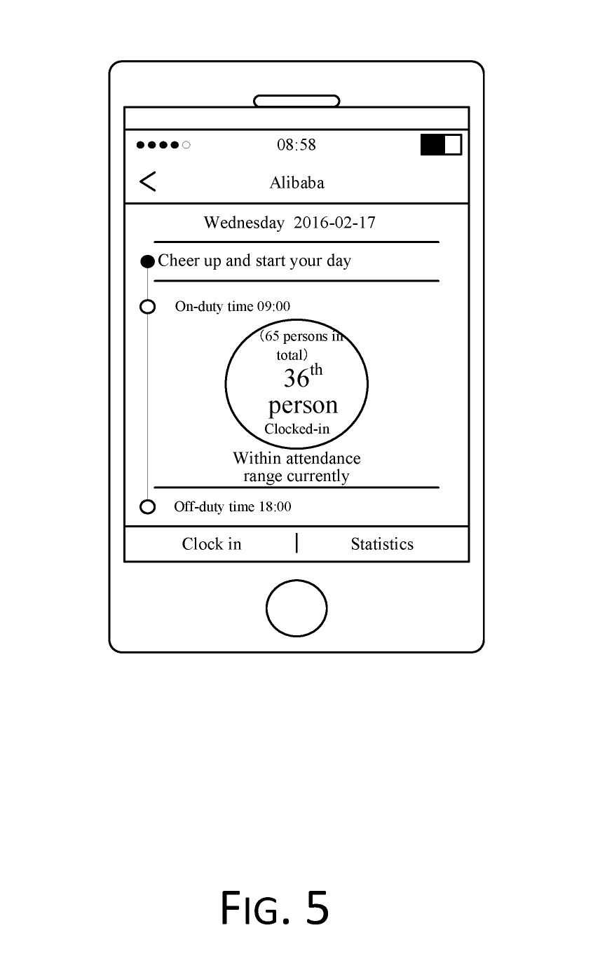

In an embodiment, as shown in FIG. 5, it is assumed that there are 65 persons in total in the group to which the user belongs, and the current attendance rank of the user is 36; thus, it may be shown that the attendance rank is “36^{th}”.

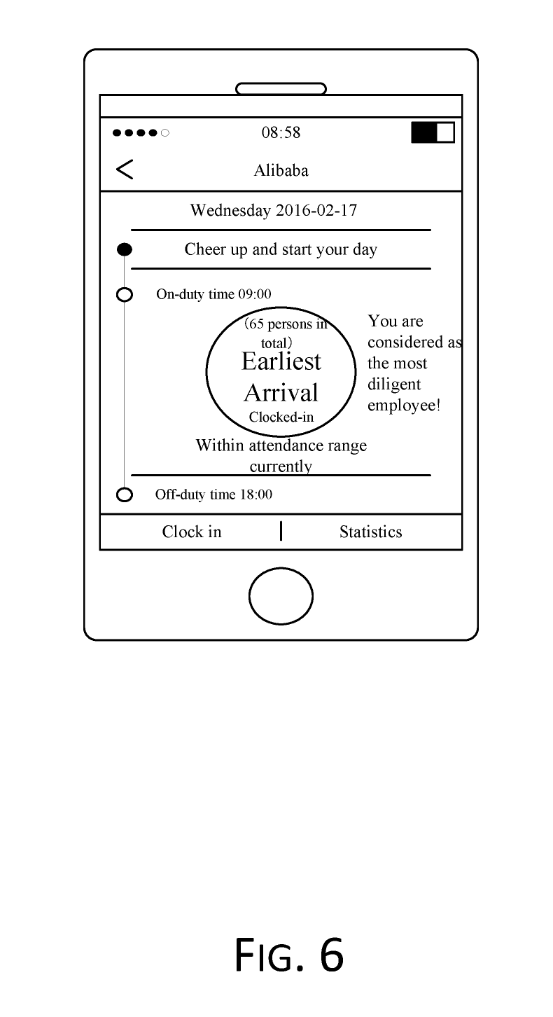

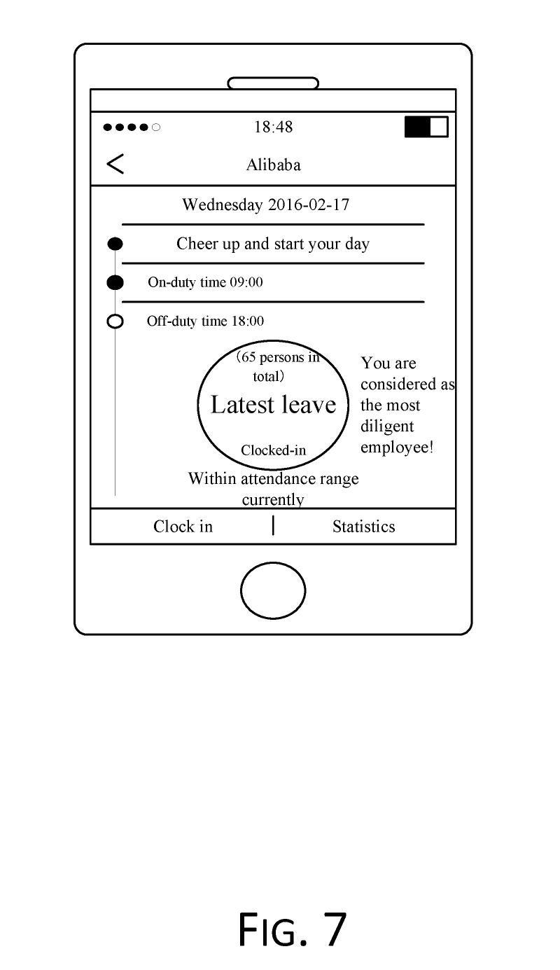

In an embodiment, a special attendance rank presenting manner may be used for users at front positions in the attendance ranking. For example, as shown in FIG. 6, for the first on-duty user, a manner such as “earliest arrival” may be adopted to express that the attendance rank of the user is the first. Similarly, as shown in FIG. 7, a manner such as “last leave” may be adopted to express that the attendance rank of the user is the first.

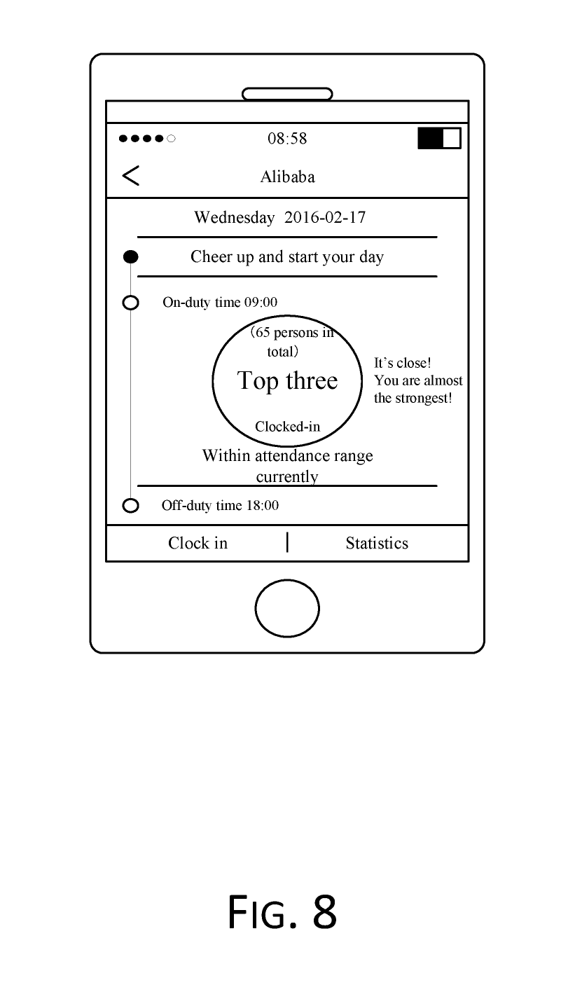

For a user at a front position but not the first position in the attendance ranking, e.g., a user having the second rank or the third rank, as shown in FIG. 8, a manner such as “top three” may be adopted to express the attendance rank while increasing enjoyment.

Step 206A: Preset prompt information is presented.

In this embodiment, corresponding preset prompt information may be presented to help the user understand his/her attendance status. The preset prompt information may include at least one of the following: an attendance rank, and evaluative description information for the attendance rank. The preset prompt information may be presented in different manners for different attendance ranks.

In an embodiment, a praise text for a user may be presented. For example, when the attendance rank of the user is the first, “You are considered as the most diligent employee!” as shown in FIG. 6 and FIG. 7 may be adopted to help the user keep the good attendance habit.

In an embodiment, when the user ranks at a front position but not the first, an inspiration text such as “It's close! You are almost the strongest!” as shown in FIG. 8 may be used to help the user keep striving for a better attendance rank.

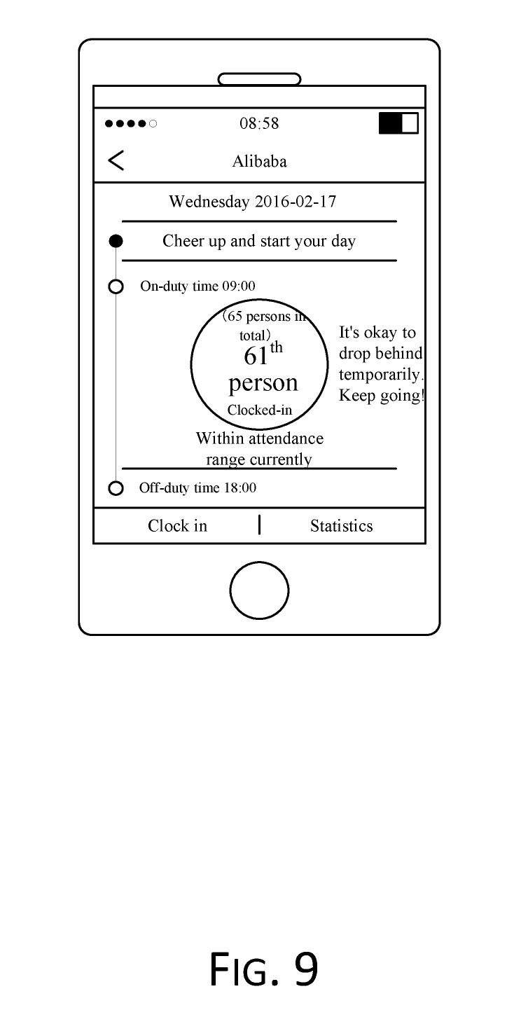

In an embodiment, for a user having a low attendance rank, for example, the user falls within “last 10%” in the attendance ranking as shown in FIG. 9, in addition to the attendance rank such as “61^{st}”, an encouragement text such as “It's okay to drop behind temporarily. Keep going!” may also be shown to help the user keep striving to improve his/her attendance rank.

Step 208: A virtual medal is provided as a reward.

In this embodiment, a diligence degree of a corresponding user may be determined according to the attendance rank, and a preset service object may be allocated to the user when the diligence degree reaches a preset degree. For the on-duty attendance, the user performing the attendance operation earlier indicates that the user starts the corresponding work or study earlier, that is, the user is relatively more diligent, thus having a higher attendance rank. For the off-duty attendance, the user performing the attendance operation later indicates that the user finishes the corresponding work or study later, that is, the user is relatively more diligent, thus having a higher attendance rank.

Certainly, the diligence degree may be obtained with reference to the on-duty attendance alone, the off-duty attendance alone, or both the on-duty attendance and the off-duty attendance. For example, when reference is made to both the on-duty attendance and the off-duty attendance, the on-duty attendance rank and the off-duty attendance rank of the same user in a day may be added together, and a smaller obtained value indicates a higher diligence degree of the user.

Therefore, a rank value corresponding to a preset degree may be set. When an independent attendance rank value or a comprehensive attendance rank value reaches the rank value, it may be considered that the diligence degree of the user reaches the preset degree, and a preset service object may be allocated to the user to provide a reward for the user, thus helping the user maintain or further improve his/her attendance rank.

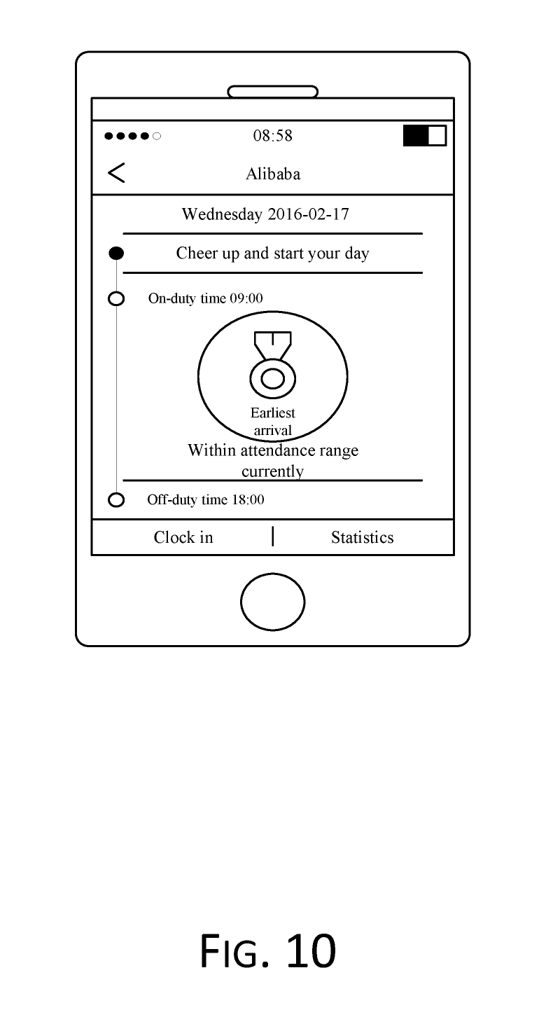

In this embodiment, the preset service object allocated to the user may include a presentable virtual medal image. As shown in FIG. 10, when an individual attendance rank of the user is considered, for example, if the on-duty attendance rank of the user is the first, a virtual medal as shown in FIG. 10 may be allocated to the user.

In this embodiment, in addition to the virtual medal, other types of preset service objects may also be allocated to the user. The other types of preset service objects may be virtual articles such as “bonus” and “latecomer impunity coupon”, and may also be various real objects, which is not limited in the present disclosure.

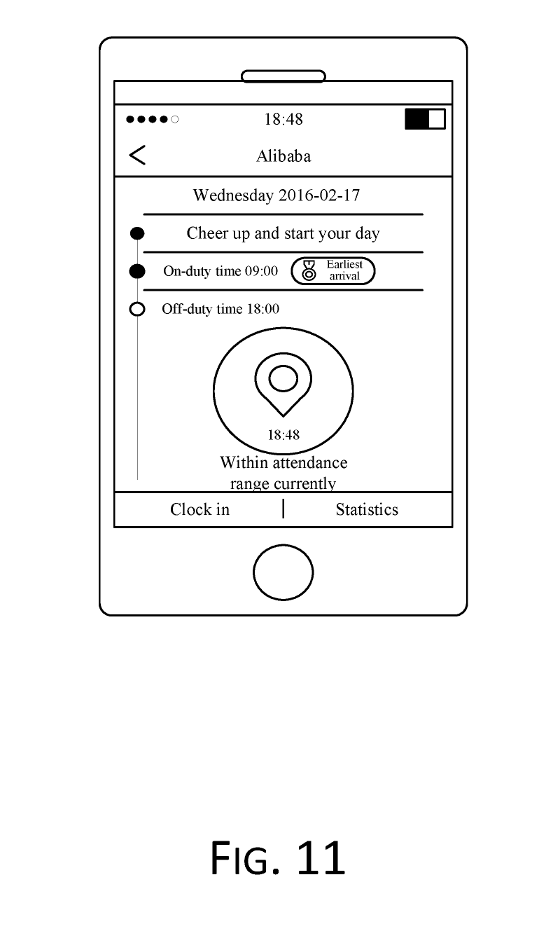

If it is in a standard attendance range corresponding to a preset attendance event currently, presentation may be performed in a detailed manner, specifically referring to the presenting manners of the attendance rank, the evaluative description information for the attendance, the virtual medal, and the like in the embodiments shown in FIG. 5 to FIG. 10. If it is not in the standard attendance range corresponding to the preset attendance event currently, presentation may be performed in a brief manner. For example, as shown in FIG. 11, assuming that it is in a standard attendance range of off-duty attendance currently, preset prompt information, a virtual medal and the like related to the on-duty attendance may be presented. For example, a virtual medal and a text of “earliest arrival” are presented on right of “on-duty time 09:00” in FIG. 11.

Step 210: The virtual medal is exchanged for a reward.

In this embodiment, the user may exchange a preset quantity of virtual medals for a corresponding preset reward. As such, the user is more enthusiastic about obtaining the virtual medal, thus helping the user achieve better attendance status. For example, the preset reward may be virtual articles such as “bonus” and “latecomer impunity coupon”, and may also be various real objects, which is not limited in the present disclosure.

Step 204B: A preset feature attribute is acquired and presented.

In this embodiment, a preset feature attribute of an attendance operation performed by the user may be acquired. For example, the preset feature attribute may include at least one of the following: an attendance time, an attendance site, and so on. Each attendance event has a pre-defined standard attendance range (such as a standard attendance time and a standard attendance site). For example, “arriving at the company before 9:00 am” indicates that the standard attendance time is “before 9:00 am” and the standard attendance site is “company”. However, the user may fail to accurately meet the foregoing standard attendance time and standard attendance site due to various reasons. Therefore, an actual attendance time and an actual attendance site may be shown such that the user may conveniently view and adjust his/her attendance status accordingly.

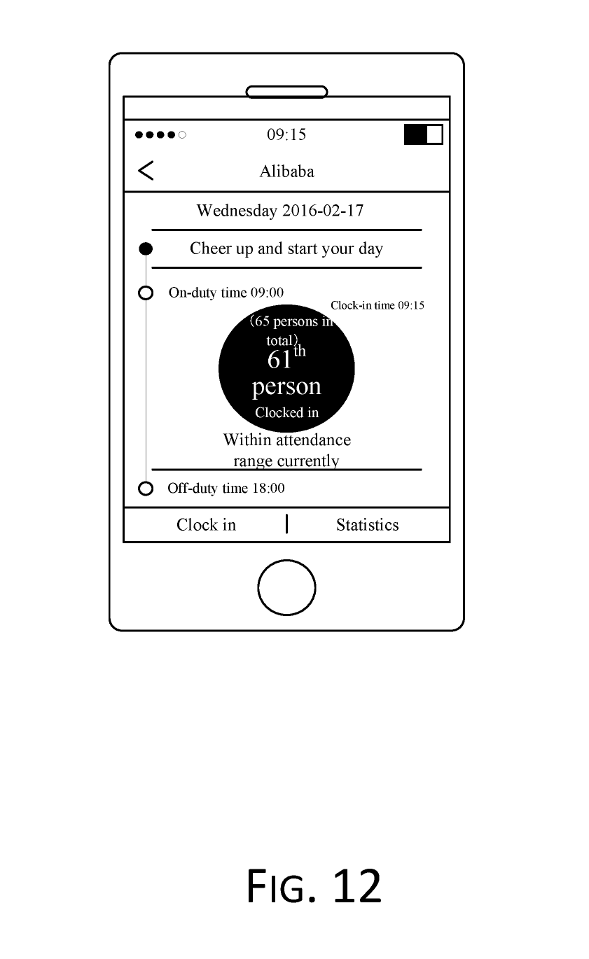

For example, as shown in FIG. 12, the attendance time of the user is shown as “clock-in time 09:15”, and the attendance time has exceeded the “on-duty time 09:00”. Meanwhile, “within the attendance range currently” indicates that the attendance site confirms to the pre-defined standard attendance site.

Step 206B: A warning prompt is provided to the user when a value of the preset feature attribute exceeds the predefined standard attendance range.

In this embodiment, a warning prompt is provided to the user, so that the user may note his/her problem, thus helping the user adjust his/her attendance status and achieve good studying or working habits.

For example, as shown in FIG. 12, it is assumed that the time when the user presses “clock in” is “09:15”, which has exceeded the preset attendance time “09:00”, i.e., exceeded the pre-defined standard attendance range. Therefore, a presentation color of a preset presentation object in the page may be replaced with a preset warning color. For example, a background color of a round icon in the middle of the page in FIG. 12 may be changed to a particular color such as red, to provide a warning and prompt to the user visually, thus achieving a more visual and effective warning effect. Similarly, a warning prompt may also be provided by an attendance site. For example, when a pre-defined attendance site is a company or a building of a company, an electronic device may directly acquire a current location of a user through GPS positioning information. Alternatively, whether the current location of the user conforms to the pre-defined attendance site may be identified according to whether the electronic device detects or is connected to a wireless local network in the range of the company. A warning prompt is presented when the current location of the user does not conform to the pre-defined attendance site, which is not described in detail here.

A warning degree of the warning prompt presented by the electronic device may be positively related to the degree by which the preset feature attribute exceeds the standard attendance range. For example, it is assumed that the pre-defined on-duty attendance time is “09:00”. When the attendance time of the user is within a time range of “09:00-09:10”, it indicates that the user is slightly late, and a light preset warning color such as light red may be used. When the attendance time of the user is within a time range of “09:10-09:30”, it indicates that the user is relatively severely late, and a dark preset warning color such as dark red may be used. When the attendance time of the user is within a time range of “after 09:30”, it indicates that the user is severely late, and the darkest preset warning color may be used.

Moreover, the warning degree of the warning prompt presented by the electronic device may be positively related to the number of times or the frequency of the user exceeding the standard attendance range of the same preset attendance event. For example, for the on-duty attendance, when the number of times or frequency of the user being late is small, e.g., less than a preset number of times or frequency, a light preset warning color such as light red may be used. When the number of times or frequency of the user being late is large, e.g., greater than a preset number of times or frequency, a dark preset warning color such as dark red may be used.

Step 208B: Assistant scenario information is acquired and presented.

In an example embodiment, assistant scenario information of a preset type and related to a preset feature attribute of an attendance operation performed by the user for a preset attendance event may be determined according to the preset feature attribute. Then, the assistant scenario information is associated with attendance information corresponding to the user and recorded in attendance record information corresponding to the preset attendance event.

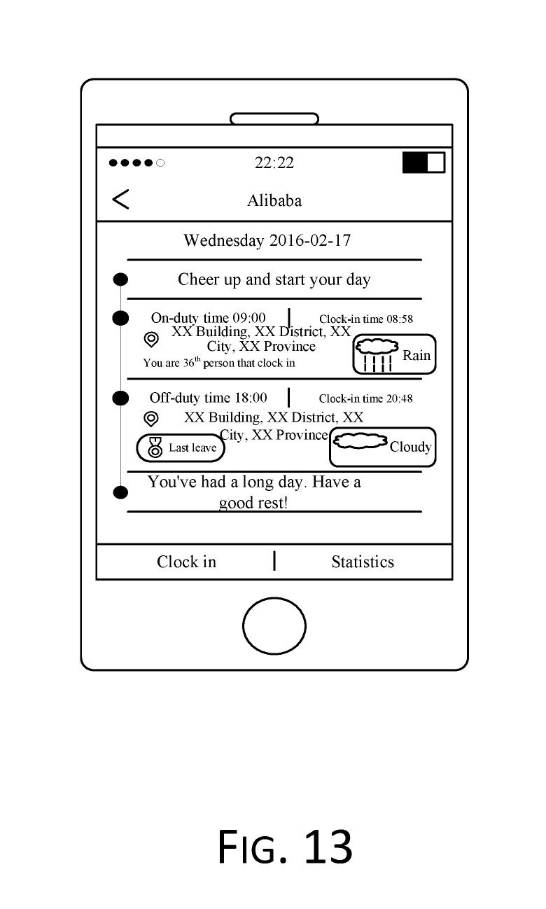

Assistant scenario information of the preset type may include at least one of the following: weather information, starry sky patterns, important events, and the like related to preset feature attributes of the attendance operation such as time and site. For example, as shown in FIG. 13, when viewing the attendance record afterwards, the user may view that he/she is the 36^{th} clock-in person in that morning, and is the last person leaving the company in the evening. Meanwhile, with reference to recorded associated weather information, the user may remember that he/she was almost late when arriving at the company due to the heavy rain and slippery road that morning, and may even remember the scenario that he/she almost slipped on the road; in the evening, he/she worked overtime in the company to wait for the rain to stop, thus being the last one leaving the company.

As shown, by means of the associated record of the assistant scenario information, when the user looks through attendance information corresponding to a preset attendance event after a long time, the user may also view the assistant scenario information while viewing the attendance record, thus helping the user remember the historical scenario at that time and further improving user experience.

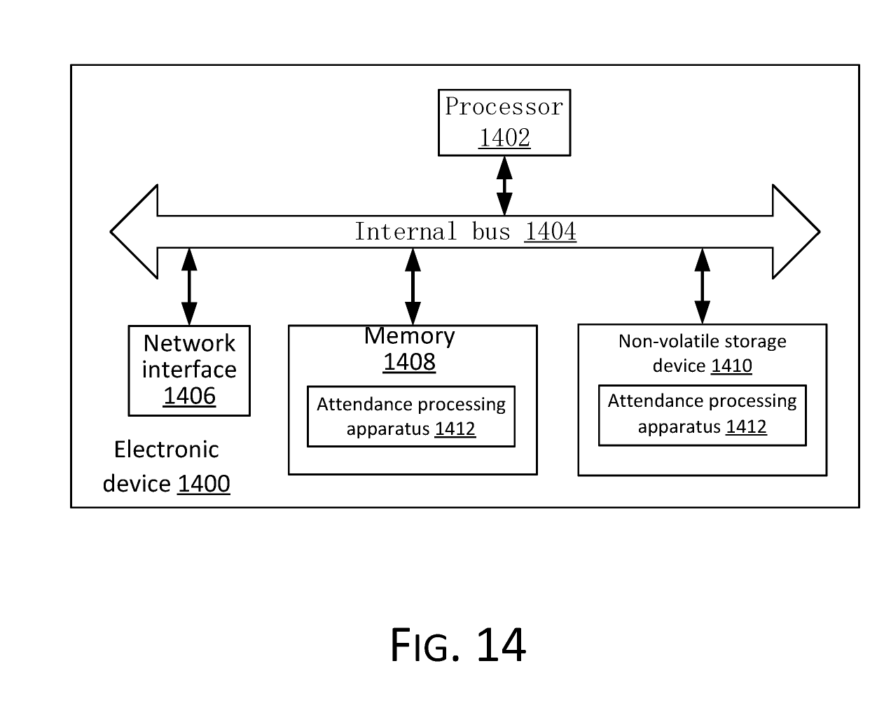

FIG. 14 is a schematic structural diagram of an electronic device 1400 according to an example embodiment of the present disclosure. Referring to FIG. 14, on hardware level, the electronic device 1400 includes a processor 1402, an internal bus 1404, a network interface 1406, a memory 1408, and a non-volatile storage device 1410, and certainly, may further include hardware required by other services. The processor 1402 reads a corresponding computer program or computer readable instructions from the non-volatile storage device 1410 to the memory 1408 and runs the computer program or computer readable instructions, thereby forming an attendance processing apparatus 1412 on logic level. Certainly, in addition to the software implementation, the present disclosure does not exclude other implementations, such as logic devices or a combination of software and hardware. In other words, execution bodies of the following processing procedure are not limited to various logic units, and may also be hardware or logic devices.

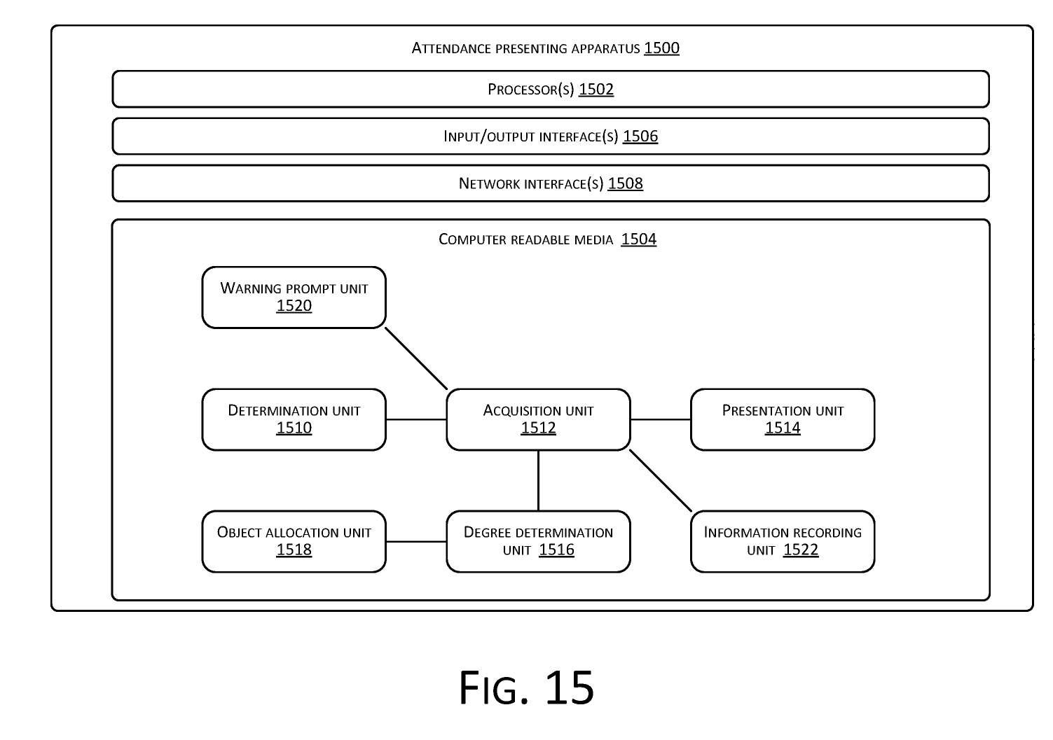

Referring to FIG. 15, an attendance processing apparatus 1500 includes one or more processor(s) 1502 or data processing unit(s) and computer readable media 1504. The attendance presenting apparatus 1500 may further include one or more input/output interface(s) 1506 and one or more network interface(s) 1508.

The computer readable media 1504 may store therein a plurality of modules or units including a determination unit 1510, an acquisition unit 1512, and a presentation unit 1514, wherein:

the determination unit 1510 is configured to determine a preset attendance event corresponding to a group to which a user belongs;

the acquisition unit 1512 is configured to acquire attendance-related information corresponding to the user in the preset attendance event; and

the presentation unit 1514 is configured to present the attendance-related information to the user.

Optionally, the acquisition unit 1512 is configured to:

determine an attendance rank of the user in the preset attendance event, and use the attendance rank as the attendance-related information.

Optionally, the acquisition unit 1512 is further configured to:

acquire preset prompt information related to the attendance rank, and use the preset prompt information as the attendance-related information.

Optionally, the preset prompt information includes at least one of the following: the attendance rank, and evaluative description information for the attendance rank.

Optionally, the attendance presenting apparatus 1500 further includes the following units or modules stored on the computer readable media 1504:

a degree determination unit 1516 configured to determine a diligence degree of the user according to the attendance rank; and

an object allocation unit 1518 configured to allocate a preset service object to the user when the diligence degree reaches a preset degree.

Optionally, the preset service object includes a presentable virtual medal image.

Optionally, the acquisition unit 1512 is further configured to:

acquire a preset feature attribute of an attendance operation performed by the user, and use the preset feature attribute as the attendance-related information.

Optionally, the predetermined feature attribute includes at least one of the following: an attendance time and an attendance site.

Optionally, the attendance presenting apparatus 1500 further includes the following unit or module stored on the computer readable media 1504:

a warning prompt unit 1520 configured to present a warning prompt to the user when a value of the preset feature attribute exceeds a predefined standard attendance range.

Optionally, a warning degree of the warning prompt is positively related to the degree by which the preset feature attribute exceeds the standard attendance range.

Optionally, the warning prompt unit 1520 is configured to:

replace a presentation color of a preset presentation object with a preset warning color.

Optionally, the acquisition unit 1502 is configured to:

determine assistant scenario information of a preset type that is related to a preset feature attribute according to the preset feature attribute of the attendance operation performed by the user, and use assistant scenario information of the preset type as the attendance-related information.

Optionally, the attendance presenting apparatus 1500 further includes the following unit or module stored on the computer readable media 1504:

an information recording unit 1522 configured to associate the assistant scenario information with attendance information corresponding to the user, and record the assistant scenario information in attendance record information corresponding to the preset attendance event.

Optionally, the presentation unit 1514 is configured to:

present a trigger identifier for the preset attendance event in an associated presentation region corresponding to the preset attendance event in the attendance page, wherein a corresponding attendance operation is accomplished when a user-triggered operation for the trigger identifier is detected; and

present the attendance-related information in the trigger identifier.

Optionally, the attendance operation of the user for the preset attendance event is accomplished by using a preset instant messaging application.

Optionally, the preset instant messaging application is an enterprise instant messaging application.

In a typical configuration, a computer device includes one or more processors (CPU), an input/output interface, a network interface, and a memory.

The memory may include a volatile memory, a random access memory (RAM) and/or a non-volatile storage device or the like in a computer readable medium, for example, a read-only memory (ROM) or a flash RAM. The memory is an example of the computer readable medium.

The computer readable medium includes non-volatile and volatile media as well as movable and non-movable media, and may implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition of this text, the computer readable medium or media do not include transitory media, such as a modulated data signal and a carrier.

It should be further noted that, the term “include”, “comprise” or other variations thereof are intended to cover non-exclusive inclusion, so that a process, method, commodity or device including a series of elements not only includes the elements, but also includes other elements not clearly listed, or further includes elements inherent to the process, method, commodity or device. In a case without any more limitations, an element defined by “including a(n) . . . ” does not exclude that the process, method, commodity or device including the element further has other identical elements.

The above descriptions are merely example embodiments of the present disclosure, and are not intended to limit the present disclosure. Any modification, equivalent replacement and improvement made within the spirit and principle of the present disclosure shall fall within the protection scope of the present disclosure.

The present disclosure may further be understood with clauses as follows.

Clause 1. An attendance processing method comprising:

determining a preset attendance event corresponding to a group to which a user belongs;

acquiring attendance-related information corresponding to the user in the preset attendance event; and

presenting the attendance-related information to the user.

Clause 2. The method of clause 1, wherein the acquiring the attendance-related information corresponding to the user in the preset attendance event comprises:

determining an attendance rank of the user in the preset attendance event; and

using the attendance rank as the attendance-related information.

Clause 3. The method of clause 2, wherein the acquiring the attendance-related information corresponding to the user in the preset attendance event further comprises:

acquiring preset prompt information related to the attendance rank; and

using the preset prompt information as the attendance-related information.

Clause 4. The method of clause 3, wherein the preset prompt information comprises at least one of the following:

the attendance rank; and

evaluative description information for the attendance rank.

Clause 5. The method of clause 2, further comprising:

determining a diligence degree of the user according to the attendance rank; and

allocating a preset service object to the user when the diligence degree reaches a preset degree.

Clause 6. The method of clause 5, wherein the preset service object comprises a presentable virtual medal image.

Clause 7. The method of clause 1, wherein the acquiring the attendance-related information corresponding to the user in the preset attendance event comprises:

acquiring a preset feature attribute of an attendance operation performed by the user; and

using the preset feature attribute as the attendance-related information.

Clause 8. The method of clause 7, wherein the preset feature attribute comprises at least one of the following:

an attendance time; and

an attendance site.

Clause 9. The method of clause 7, further comprising:

presenting a warning prompt to the user when a value of the preset feature attribute exceeds a predefined standard attendance range.

Clause 10. The method of clause 9, wherein a warning degree of the warning prompt is positively related to a degree by which the preset feature attribute exceeds the predefined standard attendance range.

Clause 11. The method of clause 9, wherein the presenting the warning prompt to the user when the value of the preset feature attribute exceeds the predefined standard attendance range comprises:

replacing a presentation color of a preset presentation object with a preset warning color.

Clause 12. The method of clause 1, wherein the acquiring the attendance-related information corresponding to the user in the preset attendance event comprises:

determining assistant scenario information of a preset type that is related to a preset feature attribute according to the preset feature attribute of the attendance operation performed by the user; and

using the assistant scenario information of the preset type as the attendance-related information.

Clause 13. The method of clause 12, further comprising:

associating the assistant scenario information with attendance information corresponding to the user; and

recording the assistant scenario information in attendance record information corresponding to the preset attendance event.

Clause 14. The method of clause 1, wherein the presenting the attendance-related information to the user comprises:

presenting a trigger identifier for the preset attendance event in an associated presentation region corresponding to the preset attendance event in the attendance page, wherein a corresponding attendance operation is accomplished when a user-triggered operation for the trigger identifier is detected; and presenting the attendance-related information in the trigger identifier.

Clause 15. The method of clause 1, wherein the attendance operation of the user for the preset attendance event is accomplished by using a preset instant messaging application.

Clause 16. The method of clause 15, wherein the preset instant messaging application is an enterprise instant messaging application.

Clause 17. An attendance processing apparatus comprising:

a determination unit configured to determine a preset attendance event corresponding to a group to which a user belongs;

an acquisition unit configured to acquire attendance-related information corresponding to the user in the preset attendance event; and

a presentation unit configured to present the attendance-related information to the user.

Clause 18. The apparatus of clause 17, wherein the acquisition unit is configured to:

determine an attendance rank of the user in the preset attendance event; and

use the attendance rank as the attendance-related information.

Clause 19. The apparatus of clause 18, wherein the acquisition unit is further configured to:

acquire preset prompt information related to the attendance rank; and

use the preset prompt information as the attendance-related information.

Clause 20. The apparatus of clause 19, wherein the preset prompt information comprises at least one of the following:

the attendance rank, and evaluative description information for the attendance rank.

Clause 21. The apparatus of clause 18, further comprising:

a degree determination unit configured to determine a diligence degree of the user according to the attendance rank; and

an object allocation unit configured to allocate a preset service object to the user when the diligence degree reaches a preset degree.

Clause 22. The apparatus of clause 21, wherein the preset service object comprises a presentable virtual medal image.

Clause 23. The apparatus of clause 17, wherein the acquisition unit is configured to:

acquire a preset feature attribute of an attendance operation performed by the user; and

use the preset feature attribute as the attendance-related information.

Clause 24. The apparatus of clause 23, wherein the predetermined feature attribute comprises at least one of the following:

an attendance time; and

an attendance site.

Clause 25. The apparatus of clause 23, further comprising:

a warning prompt unit configured to present a warning prompt to the user when a value of the preset feature attribute exceeds a predefined standard attendance range.

Clause 26. The apparatus of clause 25, wherein a warning degree of the warning prompt is positively related to a degree by which the preset feature attribute exceeds the predefined standard attendance range.

Clause 27. The apparatus of clause 25, wherein the warning prompt unit is configured to:

replace a presentation color of a preset presentation object with a preset warning color.

Clause 28. The apparatus of clause 17, wherein the acquisition unit is configured to:

determine assistant scenario information of a preset type that is related to a preset feature attribute according to the preset feature attribute of the attendance operation performed by the user; and use the assistant scenario information of the preset type as the attendance-related information.

Clause 29. The apparatus of clause 28, further comprising:

an information recording unit configured to associate the assistant scenario information with attendance information corresponding to the user, and record the assistant scenario information in attendance record information corresponding to the preset attendance event.

Clause 30. The apparatus of clause 17, wherein the presentation unit is configured to:

present a trigger identifier for the preset attendance event in an associated presentation region corresponding to the preset attendance event in the attendance page, wherein a corresponding attendance operation is accomplished when a user-triggered operation for the trigger identifier is detected; and present the attendance-related information in the trigger identifier.

Clause 31. The apparatus of clause 17, wherein the attendance operation of the user for the preset attendance event is accomplished by using a preset instant messaging application.

Clause 32. The apparatus of clause 31, wherein the preset instant messaging application is an enterprise instant messaging application.

What is claimed is:

1. A method comprising:
determining a preset attendance event corresponding to a group to which a user belongs;
acquiring attendance-related information corresponding to the user in the preset attendance event; and
presenting the attendance-related information to the user.

2. The method of claim 1, wherein the acquiring the attendance-related information corresponding to the user in the preset attendance event comprises:
determining an attendance rank of the user in the preset attendance event; and
using the attendance rank as the attendance-related information.

3. The method of claim 2, wherein the acquiring the attendance-related information corresponding to the user in the preset attendance event further comprises:
acquiring preset prompt information related to the attendance rank; and
using the preset prompt information as the attendance-related information.

4. The method of claim 3, wherein the preset prompt information comprises at least one of the following:
the attendance rank; and
evaluative description information for the attendance rank.

5. The method of claim 2, further comprising:
determining a diligence degree of the user according to the attendance rank; and
allocating a preset service object to the user in response to determining that the diligence degree reaches a preset degree.

6. The method of claim 5, wherein the preset service object comprises a presentable virtual medal image.

7. The method of claim 1, wherein the acquiring the attendance-related information corresponding to the user in the preset attendance event comprises:
acquiring a preset feature attribute of an attendance operation performed by the user; and
using the preset feature attribute as the attendance-related information.

8. The method of claim 7, wherein the preset feature attribute comprises at least one of the following:
an attendance time; and
an attendance site.

9. The method of claim 7, further comprising:
presenting a warning prompt to the user in response to determining that a value of the preset feature attribute exceeds a predefined standard attendance range.

10. The method of claim 9, wherein a warning degree of the warning prompt is positively related to a degree by which the preset feature attribute exceeds the predefined standard attendance range.

11. The method of claim 9, wherein the presenting the warning prompt to the user when the value of the preset feature attribute exceeds the predefined standard attendance range comprises:
replacing a presentation color of a preset presentation object with a preset warning color.

12. The method of claim 1, wherein the acquiring the attendance-related information corresponding to the user in the preset attendance event comprises:
determining assistant scenario information of a preset type that is related to a preset feature attribute according to the preset feature attribute of the attendance operation performed by the user; and
using the assistant scenario information of the preset type as the attendance-related information.

13. The method of claim 12, further comprising:
associating the assistant scenario information with attendance information corresponding to the user; and
recording the assistant scenario information in attendance record information corresponding to the preset attendance event.

14. The method of claim 1, wherein the presenting the attendance-related information to the user comprises:
presenting a trigger identifier for the preset attendance event in an associated presentation region corresponding to the preset attendance event in the attendance page, wherein a corresponding attendance operation is accomplished when a user-triggered operation for the trigger identifier is detected; and
presenting the attendance-related information in the trigger identifier.

15. The method of claim 1, wherein the attendance operation of the user for the preset attendance event is accomplished by using a preset instant messaging application.

16. The method of claim 15, wherein the preset instant messaging application is an enterprise instant messaging application.

17. An apparatus comprising:
one or more processors; and
one or more memories storing thereon computer-readable instructions that, when executed by the one or more processors, cause the one or more processors to perform acts comprising:
determining a preset attendance event corresponding to a group to which a user belongs;
acquiring attendance-related information corresponding to the user in the preset attendance event; and
presenting the attendance-related information to the user.

18. The apparatus of claim 17, wherein the acquiring the attendance-related information corresponding to the user in the preset attendance event comprises:
determining an attendance rank of the user in the preset attendance event; and
using the attendance rank as the attendance-related information.

19. The apparatus of claim 18, wherein the acquiring the attendance-related information corresponding to the user in the preset attendance event further comprises:
acquiring preset prompt information related to the attendance rank; and
using the preset prompt information as the attendance-related information.

20. One or more memories storing thereon computer-readable instructions that, when executed by one or more processors, cause the one or more processors to perform acts comprising:
determining a preset attendance event corresponding to a group to which a user belongs;
acquiring attendance-related information corresponding to the user in the preset attendance event; and
presenting the attendance-related information to the user.
